(19) United States
(12) Patent Application Publication
(10) Pub. No.: US 2018/0350169 A1
(43) Pub. Date: Dec. 6, 2018

(54) METHOD AND DEVICE FOR MONITORING THE FUNCTIONING OF A CRANKCASE VENTILATION SYSTEM OF AN INTERNAL COMBUSTION ENGINE

(71) Applicants: Hengst SE & Co. KG, Muenster (DE); Hengst of North America, Inc., Camden, SC (US)

(72) Inventors: Stephan AHLBORN, Senden (DE); David Mark POLLOCK, Hartland, MI (US)

(21) Appl. No.: 15/614,696

(22) Filed: Jun. 6, 2017

(51) Int. Cl. G07C 5/08; F01M 13/04; G07C 5/00

(52) U.S. Cl. CPC G07C 5/0808; G07C 5/0825; G07C 5/008; F01M 13/04

(57) ABSTRACT

A method and a device for monitoring the functioning of a crankcase ventilation system of an internal combustion engine, crankcase ventilation gas being supplied to an intake line of the internal combustion engine via at least one crankcase ventilation line from the crankcase via an oil separator and a crankcase pressure regulating valve. An immediate surrounding environment of the internal combustion engine is monitored by at least one sensor that is sensitive to crankcase ventilation gas or to at least one crankcase ventilation gas component for the occurrence of crankcase ventilation gas, and that, if a presence of crankcase ventilation gas is determined, an informative or warning message is produced.

### BACKGROUND OF THE INVENTION

The present invention relates to a method for monitoring the functioning of a crankcase ventilation system of an internal combustion engine, crankcase ventilation gas being supplied to an intake line of the internal combustion engine via at least one crankcase ventilation line from the crankcase via an oil separator and a crankcase pressure regulating valve.

In addition, the present invention relates to a device for monitoring the functioning of a crankcase ventilation system of an internal combustion engine, at least one crankcase ventilation line being routed from the crankcase to an intake line of the internal combustion engine, and an oil separator and a crankcase pressure regulating valve being situated in the course of the crankcase ventilation line.

In addition to the combustion exhaust gases, led away by an exhaust system of an internal combustion engine through exhaust gas purification devices such as oxidation catalytic converters, particle filters, and similar known devices, in internal combustion engines so-called blowby gas also occurs, which travels from the combustion chambers of the cylinders of the internal combustion engine into its crankcase. The above-mentioned crankcase ventilation system of the internal combustion engine acts to carry off the blowby gas from the crankcase and to prevent damaging excess pressures in the crankcase, crankcase ventilation gas being supplied to an intake line of the internal combustion engine via at least one crankcase ventilation line from the crankcase via an oil separator and a crankcase pressure regulating valve. Thus, the crankcase ventilation presents a closed system that prevents crankcase ventilation gas from being emitted to the surrounding environment.

However, from relevant practical experience it is known that internal combustion engines relatively frequently have, over the long term, defects, in particular leakages, in their crankcase ventilation system that are not noticed or that are ignored. As a result, crankcase ventilation gas that is damaging to health and to the environment is in fact emitted to the surrounding environment, in an undesirable and impermissible fashion.

DE 10 2007 050 087 B3 discloses a method for monitoring the ventilation system of a crankcase of an internal combustion engine that is equipped with an intake line for supplying fresh air, or a fresh mixture, to the internal combustion engine, a ventilation line being provided that goes out from the crankcase and opens into the intake line. The known method is characterized in that in a first method step the mass flow m1 in the intake line upstream from the opening of the ventilation line, and the mass flow m2 in the intake line downstream from the opening of the ventilation line, are determined, in a second method step the enthalpy flows h′1 and h′2 are determined using these mass flows m1, m2 and the associated temperatures T1 and T2, in a third method step the difference Δh in the enthalpy flows is determined where Δh=h′2−h′1, in a fourth step the enthalpy difference Δh is integrated over a specifiable time span Δt and the integration result ΔH ascertained in this way is compared to a specifiable threshold value ΔHthreshold, and if ΔH>ΔHthreshold the proper functioning of the crankcase ventilation system is assumed, and if ΔH<ΔHthreshold the lack of proper functioning of the crankcase ventilation system is assumed. The known method is clearly expensive, because a plurality of mass flows and a plurality of temperatures have to be determined in order then to obtain, through mathematical operations, information about the functionality or non-functionality, in particular, tightness or non-tightness, of the crankcase ventilation system. As a result of the required use of a relatively large number of different sensors for the acquisition of mass flows and temperatures, in addition there is a relatively high risk of error as a result of disturbances or failure of individual sensors.

DE 10 2013 223 656 A1 indicates a method and system for detecting a leakage of a crankcase ventilation system line. For this purpose, a humidity sensor is situated in the crankcase ventilation system line, and a humidity value acquired by the sensor can provide an indication of a leakage in a crankcase ventilation system line during various engine operating conditions. The humidity sensor can, in addition, provide a diagnosis of the humidity sensor functioning and a degree of wear of the engine. In this existing art, it is regarded as disadvantageous that a leakage of the crankcase ventilation system line can be determined only indirectly, and that, in addition, due to this indirect acquisition there is a relatively high risk of incorrect notifications.

### SUMMARY OF THE INVENTION

Therefore, for the present invention an object arises of providing a method and a device of the type named above that avoid the disadvantages of the existing art and that are low in cost and at the same time reliable, and that can be used and applied in a versatile manner

According to the present invention, the first part of the object, relating to the method, is achieved by a method of the type named above wherein an immediate surrounding environment of the internal combustion engine is monitored for the occurrence of crankcase ventilation gas by at least one sensor that is sensitive to crankcase ventilation gas or at least one crankcase ventilation gas component, and wherein, if the presence of crankcase ventilation gas has been determined, an informative message or warning message is produced.

Because the at least one sensor is sensitive to crankcase ventilation gas or at least one crankcase ventilation gas component, the present invention advantageously monitors the surrounding environment of the internal combustion engine immediately for the presence of crankcase ventilation gas. This excludes sources of errors due to a merely indirect acquisition, as are known in the existing art via mass flows, temperatures, and/or humidity values. Therefore, the method according to the present invention provides reliable and secure statements concerning the state of the crankcase ventilation system of the internal combustion engine, and provides, without a time delay, indications of testing, maintenance, or repair measures that may be needed. In this way, environmental damage caused by untight crankcase ventilation systems can be avoided to the greatest possible extent.

The crankcase ventilation gas is made up of a plurality of different typical components, so that the at least one sensor can also be sensitive to different components.

In this regard, in a first development of the method it is provided that the at least one sensor is used to monitor for the occurrence of at least one of the following: carbon dioxide (CO2), water vapor (H2O), carbon monoxide (CO), nitrogen oxides (NOX), and hydrocarbons (HC). Here, the sensor, depending on its design and properties, can detect the occurrence either of only one of the named components, or also a combination of two or more of these components.

The possibility also exists that the at least one sensor is used to monitor for the presence of volatile organic compounds (VOCs). Corresponding sensors are commercially available and can be used for the method according to the present invention.

In addition or alternatively, the at least one sensor can detect the occurrence of solid and/or liquid particles in the air in the immediate surrounding environment of the internal combustion engine, because a leakage of the crankcase ventilation line generally also causes an occurrence of solid and/or liquid particles in the air in the immediate surrounding environment of the internal combustion engine.

In order to ensure a particularly high degree of reliability of the results, the present invention further proposes that, using the at least one sensor, a reference measurement is carried out while the internal combustion engine is cold and at a standstill, and that operating measurements are carried out while the internal combustion engine is running, that the results of the operating measurements are compared with the result of the reference measurement, and, if differences are present that exceed a specifiable boundary value, the informative or warning message is produced. When the internal combustion engine is cold and at a standstill, no emissions from the crankcase ventilation system can occur, so that the reference measurement carried out then is reliably based on an emissions-free state of the crankcase ventilation system.

A further measure for meeting high demands on precision is that, preferably, the monitoring is carried out while the internal combustion engine is running, by making operating measurements using at least two sensors situated at different locations in the immediate surrounding environment of the internal combustion engine, that the measurement results of the at least two sensors are compared with each other, and that, if differences are present that exceed a specifiable boundary value, the informative or warning message is produced.

In a particularly useful application of the method according to the present invention, it is provided that it is carried out at the internal combustion engine of a motor vehicle, and that operating measurements are carried out while the motor vehicle is traveling and/or while it is at a standstill. The high degree of usefulness here results, in particular, from the fact that due to the large number of motor vehicles operated in the world, whose internal combustion engines are the principal source for the emission of harmful crankcase ventilation gas into the environment, this emission can be effectively reduced using the method according to the present invention.

Different pressures occur in the crankcase of an internal combustion engine depending on the operating state, in particular, depending on the load, rotational speed, and degree of wear, and the crankcase pressure is sometimes below and sometimes above the ambient air pressure. In order to avoid unnecessary measurements that do not supply useful information, it is provided that the at least one sensor is activated only if an excess pressure, relative to an ambient air pressure, prevails in the crankcase of the internal combustion engine. Only when there is an excess pressure in the crankcase is it possible for crankcase ventilation gas to be emitted to the surrounding environment, so that it suffices to carry out measurements using the sensor or sensors only when this boundary condition is present.

The evaluation of the data acquired at an internal combustion engine using the sensor or sensors can take place in relation to reference data obtained at the same internal combustion engine. Alternatively or in addition, according to the present invention it can also be provided that data obtained at individual internal combustion engines using their sensor(s) is communicated to a central data evaluation center, and is evaluated there through comparison in order to find internal combustion engines that deviate from target data or mean value data, and that a signal that triggers an informative or warning display at relevant deviating internal combustion engines, or motor vehicles having an internal combustion engine, is sent back to these engines or vehicles. This provides a substantially enlarged reference database, which makes the statements produced using the method still more reliable.

Alternatively, it is also possible for data obtained at individual internal combustion engines by their sensor(s) to be communicated to other internal combustion engines or motor vehicles having internal combustion engines, and to be evaluated through comparison to find internal combustion engines that deviate from target data or mean value data, and for a signal that triggers an informative or warning display at relevant deviating internal combustion engines, or motor vehicles having an internal combustion engine, to be sent back to these engines or vehicles or to be produced at these engines or vehicles themselves. Thus, here the data evaluation takes place in decentralized fashion instead of centralized fashion, but in principle provides the same information about the state of the crankcase ventilation system of individual internal combustion engines.

The second part of the object, relating to the device, is achieved according to the present invention by a device of the type named above that is characterized in that at least one sensor that is sensitive to crankcase ventilation gas or to at least one crankcase ventilation gas component is situated in an immediate surrounding environment of the internal combustion engine, by which sensor an occurrence of crankcase ventilation gas can be determined, and, given a determination of the presence of crankcase ventilation gas, an informative or warning display assigned to the internal combustion engine can be activated.

With such a device, the method described above according to the present invention can reliably be carried out.

In addition, for the device it is preferably provided that the at least one sensor is sensitive to at least one of the following: carbon dioxide (CO2), water vapor (H2O), carbon monoxide (CO), nitrogen oxides (NOX), and hydrocarbons (HC).

Alternatively, the at least one sensor can be sensitive to volatile organic compounds (VOCs).

In addition, or alternatively, the at least one sensor can be sensitive to solid and/or liquid particles in the air in the immediate surrounding environment of the internal combustion engine.

In addition, the device usefully has a microprocessor having a comparator, such that a reference measurement can be carried out by the at least one sensor while the internal combustion engine is cold and is at a standstill, and operating measurements can be carried out while the internal combustion engine is running, and the measurement results of the operating measurements and the measurement result of the reference measurement can be compared to one another by the comparator, and if differences determined by the comparator are present that exceed a specifiable boundary value the informative or warning display can be activated.

Alternatively, the device has at least two sensors situated at different locations in the immediate surrounding environment of the internal combustion engine and has a microprocessor having a comparator, such that operating measurements can be carried out by the at least two sensors while the internal combustion engine is running, the measurement results of the at least two sensors can be compared with one another by the comparator, and, if differences determined by the comparator are present that exceed a specifiable boundary value, the informative or warning display can be activated. The evaluation in the microprocessor can also take place such that a time-dependent rate of rise of the measurement results is ascertained, and, if a rate of rise is present that is above a boundary value, the informative or warning display can be activated.

Preferably, it is provided that the device according to the present invention is situated at the internal combustion engine of a motor vehicle, and that operating measurements can be carried out while the motor vehicle is driving and/or while it is at a standstill.

In addition, it is proposed that the device has a crankcase pressure measurement sensor, or uses a crankcase pressure measurement sensor that is present, and that the at least one sensor is capable of being activated only when the crankcase pressure measurement sensor in the crankcase of the internal combustion engine determines the presence of an excess pressure relative to an ambient air pressure.

In order to provide advantageous and protected positioning, the at least one sensor is preferably situated in an intermediate space between a cylinder head hood and a covering or design hood, situated thereabove, of the internal combustion engine.

So that reliable measurement values can be acquired by the sensor or sensors even when the motor vehicle is driving, the at least one sensor is usefully situated in an end region, at the side of the air outflow, of the intermediate space between the cylinder head hood and the covering or design hood, situated thereabove, of the internal combustion engine.

Functionally, it is likewise advantageous for a reliable detection of crankcase ventilation gas emitting from a leak if the at least one sensor is situated in an end region, at the side of the air outflow, of an engine compartment of the internal combustion engine, under an engine hood of the motor vehicle.

In a further embodiment, relating to the device the present invention provides that the internal combustion engine, preferably an engine control device of the internal combustion engine, has allocated to it a radio interface as wireless data transmission device, such that data obtained at individual internal combustion engines by their sensor(s) are capable of being transmitted by the radio interface to a central data evaluation center, also having a radio interface, and can there be evaluated by comparison in order to find internal combustion engines deviating from target data or mean value data, and a signal that activates an informative or warning display at relevant deviating internal combustion engines can be transmitted back to these engines.

An alternative embodiment of the device provides that the internal combustion engine, preferably an engine control device of the internal combustion engine, has allocated to it a radio interface as wireless transmission device and a microprocessor as decentral data evaluation device, such that data obtained at individual internal combustion engines by their sensor(s) can be transmitted to other internal combustion engines and can be evaluated by comparison in order to find internal combustion engines that deviate from target data or mean value data, and a signal that activates an informative or warning display at relevant deviating internal combustion engines can be transmitted back to these engines or can be produced in the separate decentral data evaluation device.

### BRIEF DESCRIPTION OF THE DRAWINGS

In the following, exemplary embodiments of the present invention are explained on the basis of a drawing.

FIG. 1 shows a motor vehicle having a device for monitoring the functioning of the crankcase ventilation system of its internal combustion engine, in a schematic cross-section through the engine compartment of the motor vehicle,

FIG. 2 shows an internal combustion engine together with a device for monitoring the functioning of its crankcase ventilation system, in a schematic view, and

FIG. 3 shows a part of the device for monitoring the functioning of the crankcase ventilation system in a further embodiment, in a schematic view.

In the following description of the Figures, identical parts in the various figures of the drawing have always been provided with the same reference characters, so that all reference characters do not have to be again explained for each figure of the drawing.

### DETAILED DESCRIPTION OF THE PREFERRED EMBODIMENTS

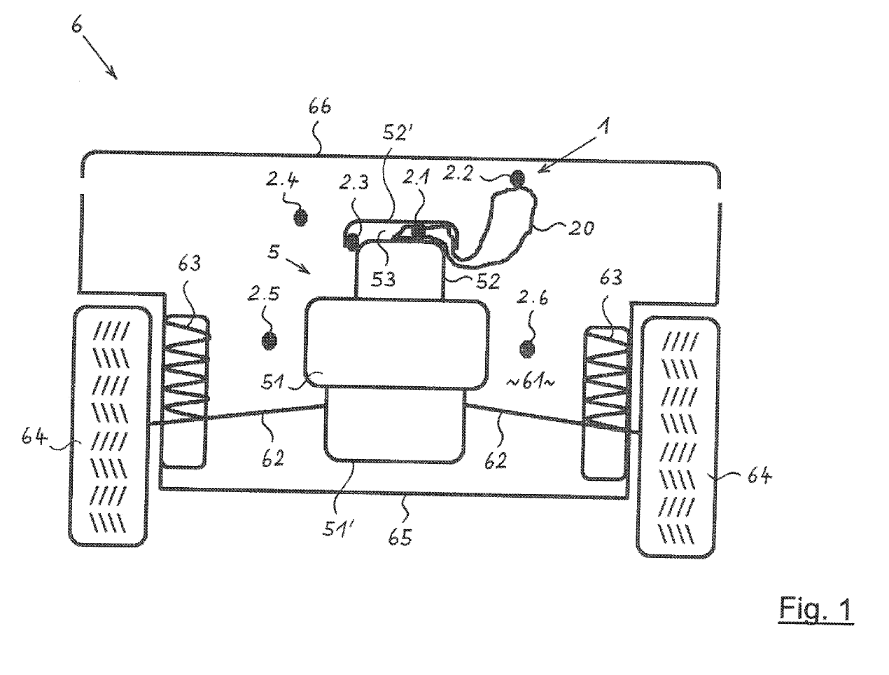

FIG. 1 of the drawing shows a motor vehicle 6 having a device 1 for monitoring the functioning of the crankcase ventilation system of its internal combustion engine 5, in a schematic cross-section through the engine compartment 61 of motor vehicle 1.

In engine compartment 61, an internal combustion engine 5 is situated in a standard manner, having a crankcase 51, an oil pan 51′ at the lower side, and having at the upper side a cylinder head hood 52 with a design hood 52′ situated thereabove. Moreover, motor vehicle 6 has, in a standard manner, a chassis having axles 62, springs 63, and wheels 64. At the lower side, engine compartment 61 is covered by a lower engine compartment cover 65, and at the upper side it is covered by an engine hood 66.

In engine compartment 61, a plurality of, here a total of six, sensors 2.1 through 2.6 are situated at various locations, which sensors are sensitive to crankcase ventilation gas or to at least one crankcase ventilation gas component. A first sensor 2.1 is situated in an intermediate space 53 between cylinder head hood 52 and design hood 52′. A second sensor 2.2 is situated in a laterally offset fashion and higher up in engine compartment 61, under engine hood 66.

When there is a leak in the crankcase ventilation system of internal combustion engine 5, an undesired emission of crankcase ventilation gas is to be expected, with highest probability, at the upper region of cylinder head hood 52, because as a rule the line or lines for the crankcase ventilation system run there, or are integrated in cylinder head hood 52.

Reference character 20 indicates a crankcase ventilation gas cloud that is emitted to the surrounding environment when there is a leak of the crankcase ventilation system. In the example shown in FIG. 1, the presence of the crankcase ventilation gas cloud is recognized on the one hand by first sensor 2.1, and subsequently also by second sensor 2.2, and is forwarded, in the form of electrical measurement signals, to an electronic evaluation unit (not shown in FIG. 1), for example in the form of a microprocessor, that is allocated to internal combustion engine 5 or to motor vehicle 6.

Depending on the airflow conditions prevailing in engine compartment 61 of motor vehicle 6, which are influenced by the travel speed of motor vehicle 6, by one or more cooling fans of internal combustion engine 5, and/or by wind in the surrounding environment of motor vehicle 6, in case of disturbance, emitted crankcase ventilation gas also moves into the region of one or more other sensors 2.1 through 2.6. The situation and distribution of sensors 2.1 through 2.6 is therefore selected such that an emission of crankcase ventilation gas is always recognized with adequate reliability under, to the greatest possible extent, all occurrent external influences and conditions.

By comparing the measurement data acquired by sensors 2.1 through 2.6 with reference data stored in the evaluation unit, it can be determined whether the crankcase ventilation system of internal combustion engine 5 is functioning properly, or whether a case of disturbance is present, with emission of crankcase ventilation gas to the surrounding environment. In the latter case, the evaluation unit activates an informative or warning display that brings the determined error to the attention of a user of motor vehicle 6, and prompts the user to remedy the error.

In addition, it can be provided that the evaluation unit prevents internal combustion engine 5 from being started if a determined error of the crankcase ventilation system is not remedied within a specifiable time span.

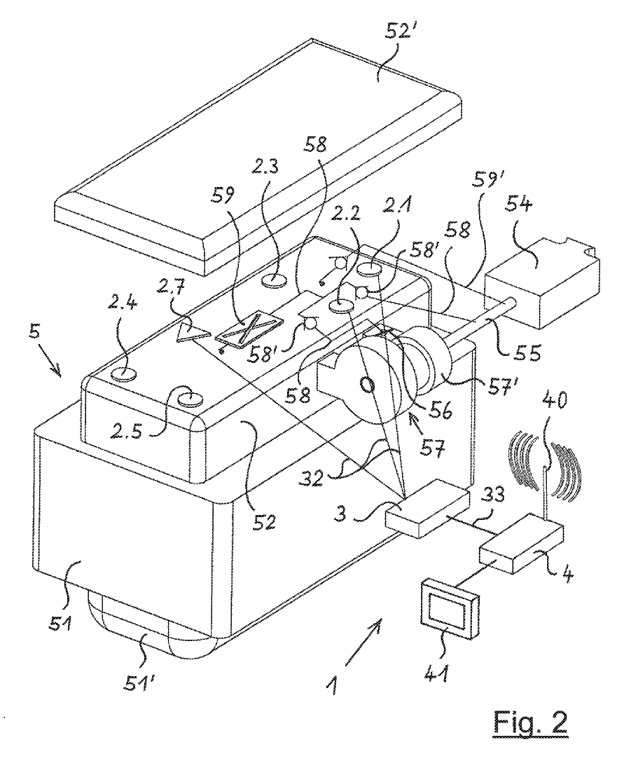

FIG. 2 shows an internal combustion engine 5 together with a device 1 for monitoring the functioning of the crankcase ventilation system of internal combustion engine 5, in a schematic view.

Here as well, internal combustion engine 5 has a crankcase 51 having an oil pan 51′ at the lower side and having a cylinder head hood 52 at the upper side. Above cylinder head hood 52, design hood 52′ is shown, here lifted and removed from cylinder head hood 52. Additionally shown in FIG. 2 are an air filter housing 54, an intake line 55 going out from this air filter housing and having a throttle valve 56 situated therein, and a turbocharger 57 having an air compressor 57′ situated in the course of intake line 55.

At the upper side of cylinder head hood 52, there runs (shown schematically here) a crankcase ventilation line 58 that stands in a flow connection with the interior of the cylinder head and of crankcase 51, via an oil separator 59. In the direction of flow, behind oil separator 59 crankcase ventilation line 58 branches into two lines, which open in a known manner into intake line 55 via a respective check valve 58′ upstream from compressor 57′ or downstream from throttle valve 56. In normal operation of internal combustion engine 5, no crankcase ventilation gas can be emitted to the surrounding environment from this closed system.

Moreover, here there is a crankcase ventilation line 59′ that branches off from intake line 55 downstream from air filter housing 54, and opens into the cylinder head and into crankcase 51.

Here, a total of five sensors 2.1 through 2.5 that are sensitive to crankcase ventilation gas or to at least one crankcase ventilation gas component are situated at the upper side of cylinder head hood 52, and are connected electrically, via a respective measurement signal line 32, to a microprocessor 3 that is allocated to internal combustion engine 5 or to an associated motor vehicle. For reasons of clarity, here only some of the measurement signal lines 32 are shown in the drawing; in reality, of course, all sensors 2.1 through 2.5 are connected to microprocessor 3. These connections can also be wireless instead of line-bound.

In addition, here a crankcase pressure measurement sensor 2.7 is situated on internal combustion engine 5, with which the pressure currently prevailing in crankcase 51 of internal combustion engine 5 can be measured, and can be communicated to microprocessor 3 via a further measurement signal line 32.

When design hood 52′ is placed onto cylinder head hood 52, there is an intermediate space between these two components in which sensors 2.1 through 2.5 are then situated, which, in the case of a leakage of crankcase ventilation line 58, or some other leak that may possibly exist, detect the presence of crankcase ventilation gas emitting from internal combustion engine 5, and report it to microprocessor 3.

Because emission of crankcase ventilation gas from internal combustion engine 5 to the surrounding environment is possible only if an excess pressure relative to the ambient air pressure is present in crankcase 51, it suffices to activate sensors 2.1 through 2.5 only when the named boundary condition is present, which can be determined by crankcase pressure measurement sensor 2.7.

Microprocessor 3, which receives and processes the measurement signals of the (here five) sensors 2.1 through 2.5 and crankcase pressure measurement sensor 2.7, is here connected to an engine control device 4 of internal combustion engine 5 via a data connection such as a bus system 33, in order to communicate data and/or evaluation results to engine control device 4. Engine control device 4 is connected to an informative or warning display 41 by which a driver of a motor vehicle equipped with internal combustion engine 5 is informed of a disturbance that may be present of the crankcase ventilation system of internal combustion engine 5.

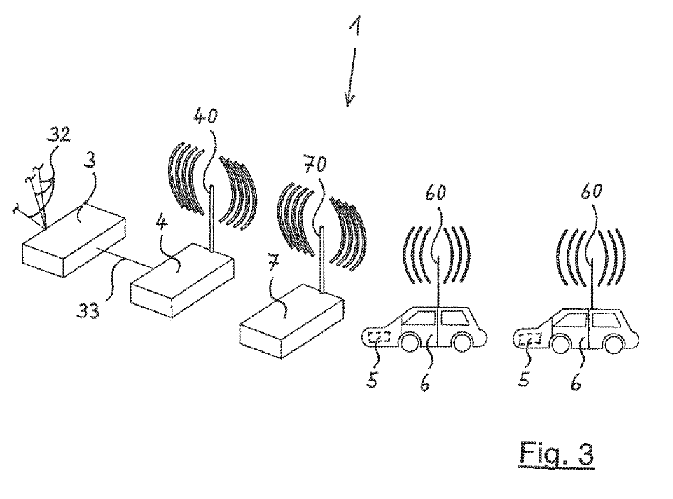

In addition, here engine control device 4 is equipped with a radio interface 40 that makes it possible for engine control device 4 to enter wirelessly into contact and data exchange with other, external units, as is explained in the following on the basis of FIG. 3.

FIG. 3 shows a part of device 1 for monitoring the functioning of the crankcase ventilation system in a further embodiment, in a schematic view.

At left in FIG. 3 are shown, as parts of the internal combustion engine 5 described above, its microprocessor 3 with measurement signal lines 32 running to it, as well as engine control device 4, with its radio interface 40, connected to microprocessor 3 via bus system 33.

Via this radio interface 40, engine control device 4 stands in wireless connection to a central data evaluation center 7, such as a data server, which has an allocated radio interface 70, or stands in wireless connection to additional motor vehicles 6, each having an associated radio interface 60, and equipped as shown in FIG. 2, or stands in wireless connection with both central data evaluation center 7 and with further motor vehicles 6.

With this, the possibility is created that data obtained at individual internal combustion engines 5, by their sensors, are communicated to central data evaluation center 7, and are evaluated there by comparison with one another in order to find internal combustion engines 5 that deviate from target data or mean value data, and that a signal that triggers an informative or warning message at relevant, deviating internal combustion engines 5, or motor vehicles 6 having an internal combustion engine 5, i.e., those having an emission of crankcase ventilation gas to the surrounding environment, is communicated back to these engines or vehicles.

Alternatively, or at the same time, here there exists the possibility that data obtained at individual internal combustion engines 5, by their sensors, are communicated to other internal combustion engines 5 or motor vehicles 6 having internal combustion engines 5, and are evaluated by comparison with one another in order to find internal combustion engines 5 that deviate from target data or mean value data, and that a signal that triggers an informative or warning message at relevant deviating internal combustion engines 5, or motor vehicles 6 having internal combustion engine 5, having an emission of crankcase ventilation gas to the surrounding environment, is communicated back to these engines or vehicles, or is produced at these engines or vehicles themselves.

Through the networking according to FIG. 3, a high degree of redundancy is achieved in the monitoring of the crankcase ventilation system of many internal combustion engines 5. In addition, in this way data from a multiplicity of internal combustion engines 5 can be collected and evaluated at a higher level.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE CHARACTERS

1 device
2.1-2.6 sensors for crankcase ventilation gas
2.7 crankcase pressure measurement sensor
20 crankcase ventilation gas cloud
3 microprocessor
32 measurement signal lines
33 bus system
4 engine control device
40 radio interface at 4
41 informative or warning display
5 internal combustion engine
51 crankcase
51′ oil pan
52 cylinder head hood
52′ design hood
53 intermediate space between 52 and 52′
54 air filter housing
55 intake line
56 throttle valve
57 turbocharger
57′ compressor of 57
58 crankcase ventilation line
58′ check valves in 58
59 oil separator in 58
59′ crankcase ventilation line
6 motor vehicles
60 radio interface at 6
61 engine compartment
62 axles
63 springs
64 wheels
65 lower engine compartment cover
66 engine hood
7 central data evaluation center
70 radio interface at 7

1. A method for monitoring the functioning of a crankcase ventilation system of an internal combustion engine, crankcase ventilation gas being supplied to an intake line of the internal combustion engine via at least one crankcase ventilation line from the crankcase via an oil separator and a crankcase pressure regulating valve, comprising the steps:
monitoring an immediate surrounding environment of the internal combustion engine by at least one sensor that is sensitive to crankcase ventilation gas or to at least one crankcase ventilation gas component for the occurrence of crankcase ventilation gas, and
producing an informative or warning message if a presence of crankcase ventilation gas is determined.

2. The method as recited in claim 1, wherein the at least one sensor monitors the occurrence of at least one of the following: carbon dioxide, water vapor, carbon monoxide, nitrogen oxides, and hydrocarbons.

3. The method as recited in claim 1, wherein the at least one sensor monitors the occurrence of volatile organic compounds.

4. The method as recited in claim 1, wherein the at least one sensor monitors the occurrence of solid and/or liquid particles in the air in the immediate surrounding environment of the internal combustion engine.

5. The method as recited in claim 1, wherein a reference measurement is carried out by the at least one sensor while the internal combustion engine is at a standstill and is cold, operating measurements are carried out while the internal combustion engine is running, the measurement results of the operating measurements are compared with the measurement result of the reference measurement, and, if differences are present that exceed a specifiable boundary value, the informative or warning message is produced.

6. The method as recited in claim 1, wherein the monitoring is carried out while the internal combustion engine is running, by operating measurements using at least two sensors situated at different locations in the immediate surrounding environment of the internal combustion engine, and wherein the measurement results of the at least two sensors are compared to one another, and wherein, if differences are present that exceed a specifiable boundary value, the informative or warning message is produced.

7. The method as recited in claim 5, wherein it is carried out at the internal combustion engine of a motor vehicle, and wherein operating measurements are carried out while the motor vehicle is traveling or is at a standstill.

8. The method as recited in claim 1, wherein the at least one sensor is activated only if an excess pressure, relative to an ambient air pressure, prevails in the crankcase of the internal combustion engine.

9. The method as recited in claim 1, wherein data obtained at the internal combustion engine by the at least one sensor are communicated to a central data evaluation center, and are evaluated there by comparison with one another in order to find an internal combustion engine that deviates from target data or mean value data, and wherein a signal that triggers an informative or warning message at a relevant, deviating internal combustion engine or a motor vehicle having an internal combustion engine is communicated back to such engine or vehicle.

10. The method as recited in claim 1, wherein data obtained at the internal combustion engine by the at least one sensor are communicated to other internal combustion engines or motor vehicles having an internal combustion engine, and are evaluated there by comparison with one another in order to find internal combustion engines that deviate from target data or mean value data, and wherein a signal that triggers an informative or warning message at relevant, deviating internal combustion engines or motor vehicles having an internal combustion engine is communicated back to these engines or vehicles or is produced at these engines or vehicles themselves.

11. A device for monitoring the functioning of a crankcase ventilation system of an internal combustion engine, at least one crankcase ventilation line being routed from the crankcase to an intake line of the internal combustion engine, and an oil separator and a crankcase pressure regulating valve being situated in the course of the crankcase ventilation line, comprising:
at least one sensor situated in an immediate surrounding environment of the internal combustion engine that is sensitive to a crankcase ventilation gas or to at least one crankcase ventilation gas component, by which sensor an occurrence of crankcase ventilation gas can be determined, and, if there is a determination of a presence of crankcase ventilation gas, an informative or warning display assigned to the internal combustion engine can be activated.

12. The device as recited in claim 11, wherein at least one sensor is sensitive to at least one of the following: carbon dioxide, water vapor, carbon monoxide, nitrogen oxides, and hydrocarbons.

13. The device as recited in claim 11, wherein the at least one sensor is sensitive to volatile organic compounds.

14. The device as recited in claim 11, wherein the at least one sensor is sensitive to solid and/or liquid particles in the air in the immediate surrounding environment of the internal combustion engine.

15. The device as recited in claim 11, further comprising a microprocessor having a comparator, a reference measurement being capable of being carried out by the at least one sensor while the internal combustion engine is at a standstill and is cold, and operating measurements being capable of being carried out while the internal combustion engine is running, the measurement results of the operating measurements and the measurement result of the reference measurement being capable of being compared to one another by the comparator, and, if differences determined by the comparator are present that exceed a specifiable boundary value, the informative or warning display being capable of being activated.

16. The device as recited in claim 11, further comprising at least two sensors situated at different locations in the immediate surrounding environment of the internal combustion engine, and a microprocessor having a comparator, operating measurements being capable of being carried out with the at least two sensors while the internal combustion engine is running, the measurement results of the at least two sensors being capable of being compared to one another by the comparator, and, if differences determined by the comparator are present that exceed a specifiable boundary value, the informative or warning display being capable of being activated.

17. The device as recited in claim 15, wherein the device is situated at the internal combustion engine of a motor vehicle, and wherein operating measurements are capable of being carried out while the motor vehicle is one of traveling or at a standstill.

18. The device as recited in claim 11, further comprising a crankcase pressure measurement sensor, and wherein the at least one sensor is capable of being activated only when the crankcase pressure measurement sensor in the crankcase of the internal combustion engine determines the presence of an excess pressure relative to an ambient air pressure.

19. The device as recited in claim 11, wherein the at least one sensor is situated in an intermediate space between a cylinder head hood and a covering or design hood, situated thereabove, of the internal combustion engine.

20. The device as recited in claim 19, wherein the at least one sensor is situated in an end region, at the air outflow side, of the intermediate space.

21. The device as recited in claim 17, wherein the at least one sensor is situated in an end region, at the air outflow side, of an engine compartment of the internal combustion engine, below an engine hood of the motor vehicle.

22. The device as recited in claim 11, wherein a radio interface is allocated to an engine control device of the internal combustion engine, as a wireless data transmission device, data obtained at the internal combustion engine by the at least one sensor being capable of being communicated by the radio interface to a central data evaluation center, also having a radio interface, and there being capable of being evaluated by comparison with data from other sensors associated with other internal combustion engines in order to find internal combustion engines that deviate from target data or mean value data, and a signal that activates an informative or warning display at relevant, deviating internal combustion engines being capable of being communicated back to these engines.

23. The device as recited in claim 11, further comprising a radio interface, as a wireless data transmission device, and a microprocessor, as a decentral data evaluation device, are allocated to an engine control device of the internal combustion engine, data obtained at the internal combustion engine by the at least one sensor being capable of being communicated to other internal combustion engines and being capable of being evaluated by comparison with data from other sensors associated with the other internal combustion engines in order to find internal combustion engines that deviate from target data or mean value data, and a signal that activates an informative or warning display at relevant, deviating internal combustion engines being capable of being communicated back to these engines, or being capable of being produced in the separate decentral data evaluation device.
